(19) United States
(12) Patent Application Publication
(10) Pub. No.: US 2005/0238795 A1
(43) Pub. Date: Oct. 27, 2005

(54) Method and arrangement for the regulation of the layer thickness of a coating material on a web moved in its longitudinal direction

(76) Inventors: Hans-Georg Lotz, Grundau-Rothenbergen (DE); Peter Sauer, Schluchtern (DE); Gerhard Steiniger, Ronneburg (DE); Gerd Hoffmann, Bruchkobel (DE); Rainer Ludwig, Hosbach (DE)

Correspondence Address: FULBRIGHT & JAWORSKI, LLP, 666 FIFTH AVE, NEW YORK, NY, 10103-3198, US

(21) Appl. No.: 10/855,984

(22) Filed: May 26, 2004

(30) Foreign Application Priority Data
Apr. 26, 2004 (EP) 04 009 789.1

(51) Int. Cl. B05D 1/00

(52) U.S. Cl. 427/10; 427/248.1; 118/718; 118/726; 118/665; 427/255.5

(57) ABSTRACT

The invention relates to a method and an arrangement for regulating the layer thickness of a coating material on a web moved in its longitudinal direction. The thickness of the layer is measured at several sites over the width of the web and a coating installation is regulated, such that the thickness of the layer is constant over the width of the web. The thickness regulation can be attained by means of intensity variations of electron beams, which vaporize a coating material. But it is also possible that several evaporator crucibles distributed over the width of the web are heated individually, such that a uniform coating results over the width of the web. With the aid of an additional transmission measuring instrument the composition of the coating material can also be regulated, such that it is constant over the width of the web.

### FIELD OF THE INVENTION

This application claims priority from European Patent Application 04 009 789.1 filed Apr. 26, 2004, which is hereby incorporated by reference in its entirety.

The invention relates to a method and arrangement for the regulation of the layer thickness of a coating material on a web moved in its longitudinal direction.

### BACKGROUND AND SUMMARY OF THE INVENTION

Glasses, foils and films and other substrates are provided with thin layers in order to lend them particular properties. Such layers are applied for example on synthetic material films to make them gastight.

For the application of these layers on the substrate different methods are known, of which only sputtering and vapor deposition will be cited. Compared to sputtering, vapor deposition has the advantage that the layers can be applied at a 10- to 100-fold rate.

A method for the vaporization of materials by means of an electron beam is already known (EP 0 910 110 A2). However, in this method the issue is the selective control of the electron beam and not the measurement of a vapor-deposited layer.

It is furthermore known to determine the layer thickness by measuring the optical absorption. However, this measuring method cannot be applied with relatively thick and weakly absorbing layers, since interference effects are superimposed onto a possibly present weak absorption signal (Quality Control and Inline Optical Monitoring for Opaque Film, AIMCAL Fall Conference, Oct. 28, 2003). The invention therefore addresses the problem of providing a regulation for a coating method, which permits keeping the thickness of largely absorption-free coating materials constant over the width of a substrate.

This problem is solved according to the present invention.

Consequently, the invention relates to a method and an arrangement for regulating the layer thickness of a coating material on a web moved in its longitudinal direction. Herein the thickness of the layer is measured at several sites over the width of the web and a coating installation is regulated, such that the thickness of the layer is constant over the width of the web. The thickness regulation can be attained by means of intensity variations of electron beams which vaporize a coating material. But it is also possible to heat individually several evaporator crucibles distributed over the width of the web, such that a uniform coating results over the width of the web. With the aid of an additional transmission measuring instrument the composition of the coating material can also be regulated, such that it is constant over the width of the web.

The advantage attained with the invention lies in particular therein that in coating by means of electron beam vaporizers the electron beam can be regulated over the width of a substrate, such that a uniform distribution of the coating material is obtained over the entire width of this substrate.

In measuring the thickness of largely absorption-free coating material, use is made of the property of dielectric layers that through interference effects in the optical spectrum maxima and minima are generated which represent a measure of the optical layer thickness.

The measured layer thickness can be utilized to control the coating process, for example the intensity and/or the deflection angle of an electron beam impinging on a material to be vaporized.

An embodiment of the invention is shown in the drawing and will be described in further detail in the following.

### BRIEF DESCRIPTION OF THE FIGURES

FIG. 1 perspective view of a vapor deposition installation for synthetic material films;

FIG. 2 a detail representation from FIG. 1, which shows a coated film;

FIG. 3 a fundamental representation of white light interferences;

FIG. 4 interferences of a light wave reflected on a surface and on a boundary layer;

FIG. 5 a reflection curve of a coating as a function of the wavelength of light;

FIG. 6 a further reflection curve of a coating as a function of the wavelength of light;

FIG. 7 a further reflection curve of a coating as a function of the wavelength of light; and

FIG. 8 several reflection curves, each of which applies to a different site of a coated substrate.

### DETAILED DESCRIPTION

FIG. 1 depicts a perspective view of a high-rate vapor deposition installation 1 according to the invention. This installation comprises two chambers 2, 3 of which the one chamber 2 includes a feed-out cylinder 4 for an uncoated synthetic material film 5 as well as an uptake cylinder 6 for a coated synthetic film 7, while the other chamber 3 is equipped with the vapor deposition installation 8 proper. Only a small portion can be seen of the second chamber 3, the larger portion is omitted in order to be able to view the vapor deposition installation 8 better. This vapor deposition installation 8 essentially comprises a crucible 9 with a material 10 to be vaporized and two electron beam guns 11, 12.

The two chambers 2, 3 are connected with one another by narrow slots, which are necessary in order to move the film 5 to be coated via guide rollers 22 to 27 from one chamber 2 or 3 into the particular other chamber 3 or 2, respectively. The pressure difference between the two chambers 2, 3 is approximately two to the power of ten.

Not shown is a magnetic deflection unit, which deflects the horizontally incident electron beams 28, 29 of the electron beam gun 11, 12 perpendicularly onto the material 10 to be vaporized. By 16 is denoted a plate, which is a part of the arrangement, which is connected with substantial parts of the entire installation. These parts can be moved out of the chamber 2 such that the chamber can be more easily maintained.

The coating of the synthetic material film 5 in installation 1 will be described in the following.

A (not shown) drive motor drives the uptake cylinder 6 in the direction of arrow 30, in which is secured the end of the coated film 7. Hereby the uncoated film 5 is wound off the feed-out cylinder 4 and, via the guide rollers 26, 27, placed onto the coating roller 25. The film 5 is here bombarded with material particles, which, due to the heating of the coating material 10 by the electron beams 28, 29, vaporize and are deposited on the film 5. The electron beams 28, 29—as indicated by the arrows 31, 32—are moved back and forth in at least one direction, such that the material 10 is vaporized over the entire length of the crucible 9.

Thereby that the coating material 10 is provided over the entire width of film 7, a vaporization intensity can be assigned to each point on the width line, i.e. the rate of vaporization of the coating material can be adjusted in the direction of the film width by correspondingly affecting the guide system and the beam intensity of the electron beam.

Instead of one crucible 9, it is also possible to provide several evaporator crucibles disposed one next to the other, such as are described in DE 40 27 034.

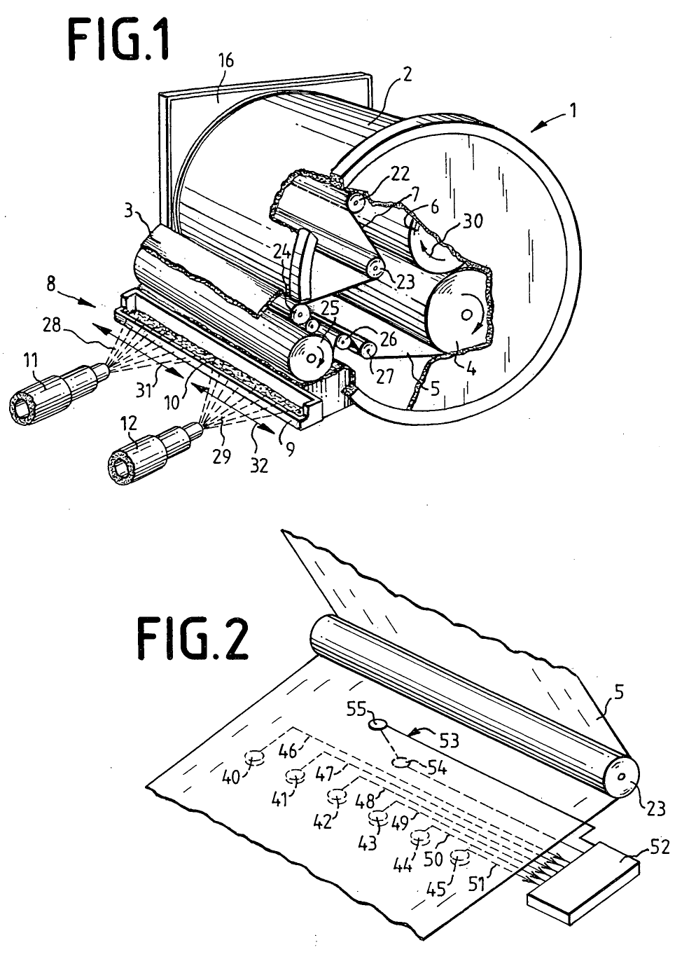

FIG. 2 depicts a partial region from FIG. 1 on an enlarged scale. Evident are here the roller 23 as well as film 5, which is guided by roller 23. The film 5 is already coated on its underside. The thickness of this layer is measured by means of several reflection measuring instruments 40 to 45. Each of these comprises a light transmitter and a light receiver. The measured reflected light signals are converted into electric signals and conducted across lines 46 to 51 to an evaluation circuit 52. The energy supply lines for the reflection measuring instruments 40 to 45 are not shown in FIG. 2.

The evaluation circuit 52 is connected to a (not shown) control for the electron beams 28, 29. The intensity or the deflection angle of these electron beams is regulated as a function of the measured layer thickness. If the layer thickness is too small over the width of the film 5 at a specific site, the vaporization is increased underneath this site, so that the layer thickness increases at this site.

Instead of electron beams, several evaporator crucibles disposed one after the other, can also be provided which can be heated individually, such that the vaporization is variable along the width of film 5.

In addition to the reflection measuring instruments 40 to 45, a transmission measuring instrument 53 can also be provided, which comprises an optical transmitter 54 beneath film 5 and an optical receiver 55 above the film. Transmitter 54 and receiver 55 are also connected to the evaluation circuit 52, which also serves as the energy supply. With an additional monochrome transmission measurement in the shortwave range (<450 nm, typically: wavelengths between 350 and 400 nm) it is possible to determine whether or not a residual absorption is present in the layer. This is apparent in differing transmission values. Thus, the layer, for example at the left margin of the film, could have a transmission (measured at 360 nm) of 5%, in the center 8% and at the right margin of the film 7%. Through the selective addition of oxygen the transmission of the film can be brought to a constant value of, for example, 8% at all measuring sites. This ensures that the oxidation state of the layer is identical at all sites of the film. The method (for weakly absorbing layers) presupposes that the layer thickness is constant over the width of the film. It can be utilized in connection with a regulation according to DE 197 45 771 A1.

The reflection measuring system carries out an automatic spectral position determination of the extreme values. The spectral positions of the extreme values serve as correcting variables for the control of the electron beams. By means of an additional transmission measurement, for which the transmission measuring instrument 53 is provided, information about potential residual absorptions of the layer could also be obtained. The absorption results from the formula A=100−R−T, were R=reflection and T=transmission. The value of absorption A serves as the correcting variable for the reactive gas inflow of the coating process and the nominal value for A is typically in the range from 0% to 10%. It is therewith possible to regulate the composition of the layer such that it is constant over the width of the web.

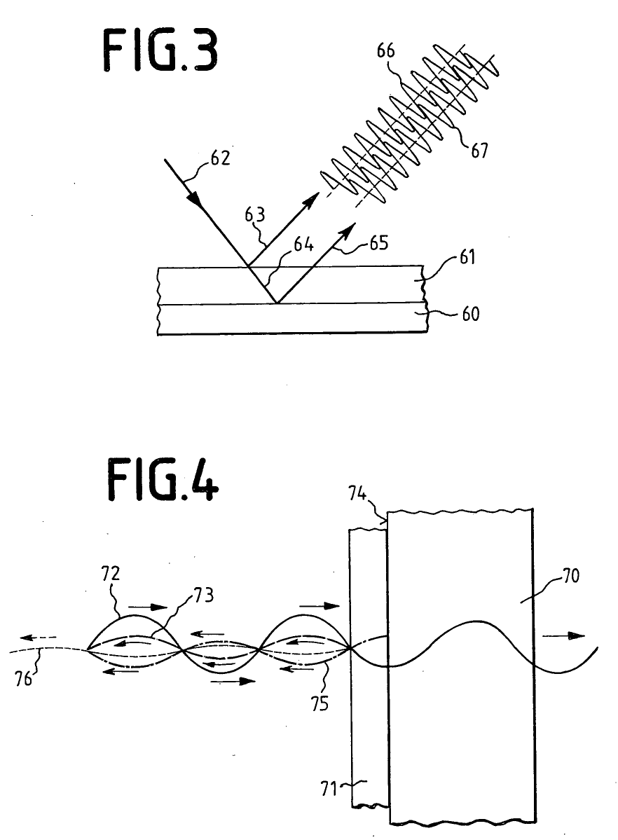

FIG. 3 shows the principle of white light interferences. On a substrate 60 is applied a layer 61 with the geometric thickness D and a white light beam 62 is incident at an angle a on the surface of layer 61. A portion of the light beam 62 is reflected as light beam 63, while another portion 64 of light beam 62 penetrates the layer 61 and is only reflected on the surface of substrate 60 as beam 65. The two light beams 63, 65 are also depicted as light waves 66, 67. These light waves 66, 67 are sinusoidal and can cancel or reinforce one another.

In FIG. 4 the interference principle is shown, however not in conjunction with a light beam, but rather of a light wave, which, moreover, is not incident at an angle but rather perpendicularly to a reflecting means. On a glass plate 70 with an index of refraction of n=1.52 is applied a layer 71 of MgF₂ with a refractive index of n=1.38. This layer 71 has a thickness of one fourth the wavelength of the incident light (λ/4). The incident light wave 72 is partially reflected on the surface of layer 71. The reflected light wave 73 has a lower amplitude than the incident light wave 72.

On the surface 74 of glass plate 70 the light wave 72 is also reflected and is superimposed as light wave 75 on the light wave 73. Since the two light waves 73, 75 are phase-shifted by 180 degrees, they cancel each other at the same amplitude. If there is a slight discrepancy of the amplitude, the resultant obtained is the light wave 76 with very small amplitude. This shows that a λ/4 layer can be viewed as an anti-reflection layer.

Mutual cancellation of waves 73 and 75 only takes place if the layer 71 has a thickness of λ/4. If it has a different thickness, the amplitude of the resulting wave 76 increases. If the wavelength is known, it is possible to draw conclusions regarding the thickness of the layer on the basis of the equation n·d=λ/4, where d is the geometric thickness and n the refractive index, by determining the maximum or the minimum of the amplitude of the reflected light wave 76. If, for example, a minimum is found at λ=480 nm, the layer has a thickness of 120 nm. Further relationships between the physical values of thin layers and the wavelength can be found in DE 39 36 541 C2.

To be able to determine the wavelength at which the amplitude of the reflected light has a minimum, the wavelength of the light guided onto the layer 71 is varied, i.e. the light passes through the range of visible light from approximately 380 to 780 nm. With the aid of spectrophotometers such wavelength changes can be measured (cf. for example Naumann/Schröder: Bauelemente der Optik, 5th edition, 1987, 16.2, pp. 483 to 487; DE 34 06 645 C2).

If, as shown in FIG. 2, the reflection is measured at several sites over the width of a film, it is useful to provide a spectrophotometer with several optical waveguides, which are all supplied by the same light source. In this case reflection curves for several sites can be measured with only one light source.

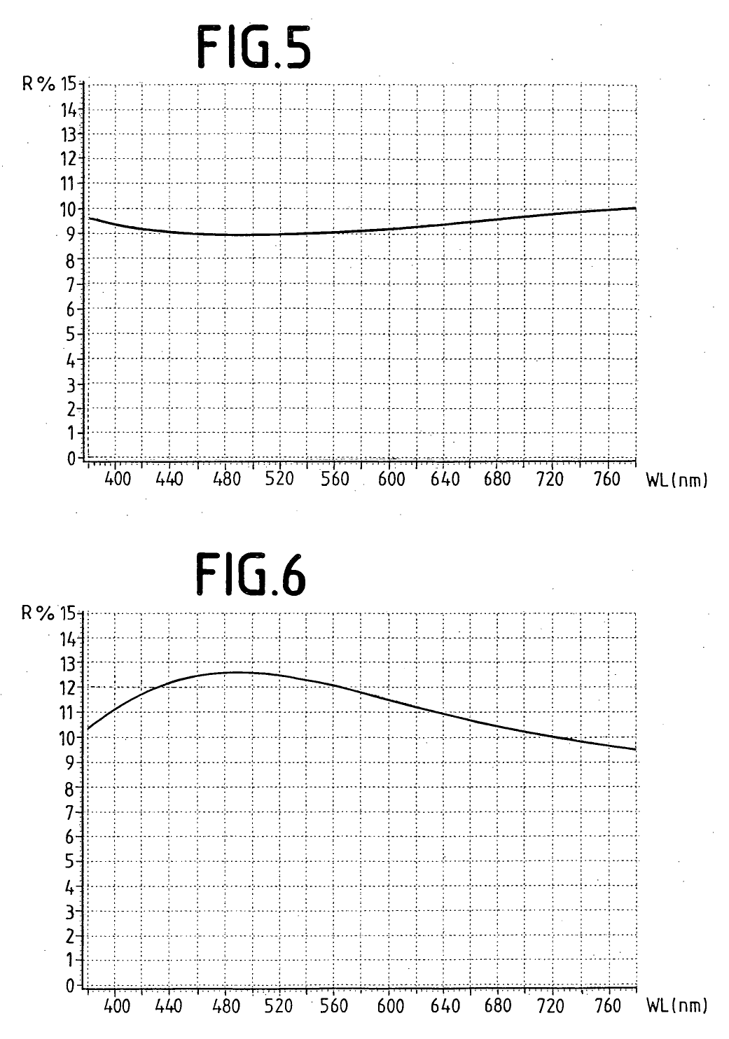

FIG. 5 shows the reflection factor of the oxide layer Al₂O₃ and a PET film, plotted in percentage over the spectrum from 380 to 780 nm. It shows a minimum at 500 nm, from which a layer thickness of 125 nm can be calculated.

FIG. 6 shows a further curve, in which the reflection factor in percentage is shown over the wavelength. It can be seen that the reflection factor has a maximum at approximately 480 nm. This means that the reflected wavelengths interfere least at 480 nm. This effect occurs when the layer thickness d=λ/2, i.e. at 240 nm.

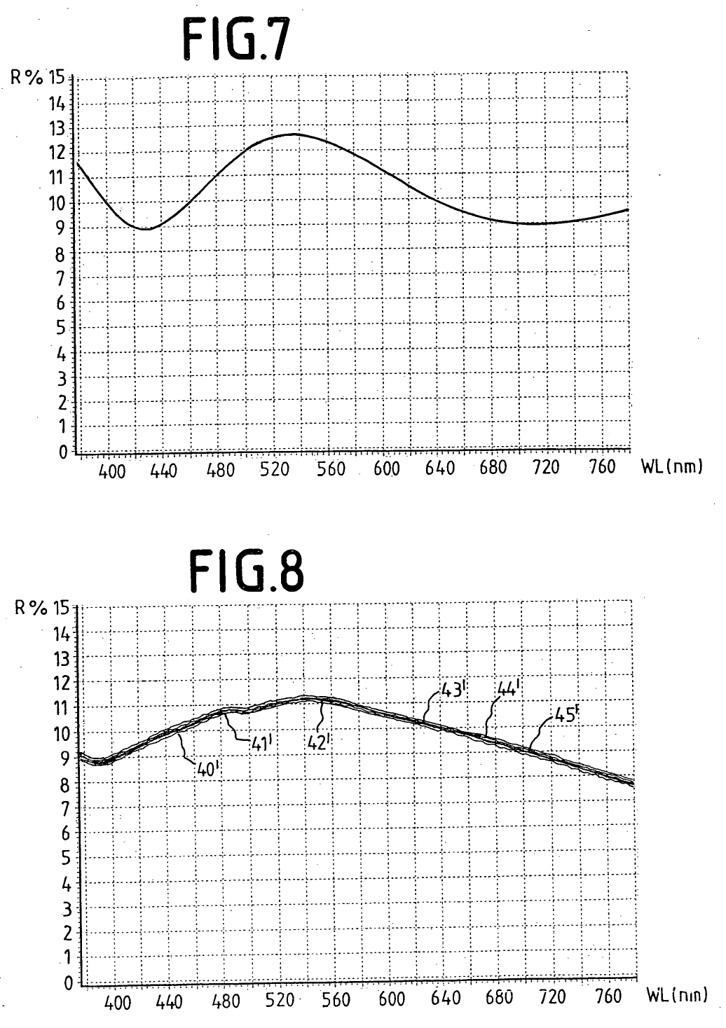

FIG. 7 shows a further reflection curve, which, however, has one maximum and two minima. Both minima and the maximum can be utilized for measuring the layer thickness.

FIG. 8 shows six reflection curves 40′ to 45′ as a function of the particular wavelengths, with the reflection curves 40′ to 45′ assigned to the particular sensors 40 to 45. These curves refer to an approximately 170 nm thick Al₂O₃ layer on PET film, which was produced by a vaporization process of aluminum with oxygen as the reactive gas. The curves are already one above the other since the regulation of the electron beam vaporizers has correspondingly optimized the vaporization power.

1-15. (canceled)

16. A method for regulating the layer thickness of a coating material on a web moved in its longitudinal direction, comprising measuring the layer thickness at several sites over the width of the web and regulating a coating installation such that the thickness of the layer is constant over the width of the web.

17. The method as claimed in claim 16, wherein the coating material is largely absorption-free.

18. The method as claimed in claim 16, wherein the layer thickness of the largely absorption-free coating material is determined by:
a) directing a light beam with variable wavelength onto the surface of the coating material;
b) measuring the reflection of the light beam on the surface of the coating material as a function of the wavelength,
c) determining the wavelength-dependent maxima or minima, present in the reflected variable light beam due to interference effects.

19. The method as claimed in claim 18, wherein at a maximum or a minimum the layer thickness d is calculated with the equation n·d=λ/4, where λ is the wavelength of the light at which the maximum or minimum occurs, and n is the refractive index.

20. The method as claimed in claim 16, wherein the coating takes place by vapor deposition of the coating material.

21. The method as claimed in claim 16, wherein the coating material is vaporized by the location-dependent heating of evaporator crucibles.

22. The method as claimed in claim 20, wherein the coating material is vaporized by electron beams and reaches the web to be coated.

23. The method as claimed in claim 22, wherein based on the measured layer thickness, the electron beams are affected such that a uniform layer thickness is obtained over the width of the web.

24. The method as claimed in claim 16, wherein the transmission of the coating material is additionally measured.

25. The method as claimed in claim 24, wherein based on the measured transmission, a reactive gas inflow is regulated.

26. The method as claimed in claim 16, wherein the vaporized material is aluminum and the reactive gas is oxygen.

27. The method as claimed in claim 16, further comprising regulating the composition of the layer such that it is constant.

28. An arrangement comprising
a) several reflection measuring instruments over the width of a film to be coated;
b) an evaluation circuit for evaluating the signals received from the reflection measuring instruments; and
c) a circuit configuration for controlling the intensity and the deflection angle of an electron beam or the heating power for evaporator crucibles, which are provided for vaporizing a coating material.

29. The arrangement as claimed in claim 28, wherein the reflection measuring instruments are connected to a common light source across optical waveguides.

30. The arrangement as claimed in claim 28, wherein a transmission measuring instrument is provided, which serves for regulating the composition of the layer.
